(19) United States
(12) Patent Application Publication
(10) Pub. No.: US 2026/0167026 A1
(43) Pub. Date: Jun. 18, 2026

(54) CHARGING DOCK HEATING ELEMENT, LEAD FRAME ASSEMBLY AND CHARGING DOCK

(71) Applicants: Tyco Electronics (Suzhou) Ltd., Suzhou City (CN); Tyco Electronics (Shanghai) Co., Ltd., Shanghai (CN); Tyco Electronics Technology (SIP) Co., Ltd., Suzhou (CN)

(72) Inventors: Renyi (Ronny) Dou, Suzhou (CN); Jinshun (Jet) Wang, Suzhou (CN); Fangyue (Jason) Zhu, Shanghai (CN)

(73) Assignees: Tyco Electronics (Suzhou) Ltd., Suzhou City (CN); Tyco Electronics (Shanghai) Co., Ltd., Shanghai (CN); Tyco Electronics Technology (SIP) Co., Ltd., Suzhou (CN)

(21) Appl. No.: 19/417,547

(22) Filed: Dec. 12, 2025

(30) Foreign Application Priority Data
Dec. 12, 2024 (CN) 202411832981.6

(51) Int. Cl. B60L 53/16; H01R 13/52; H01R 13/60; H01R 13/66

(52) U.S. Cl. CPC B60L 53/16; H01R 13/5227; H01R 13/60; H01R 13/6608; H01R 2201/26

(57) ABSTRACT

A charging dock heating element includes a body part. The body part is inserted into a slot of a housing of a charging dock. The charging dock heating element is electrically connected to a lead frame inside the housing of the charging dock. The charging dock heating element is electrically connected to a power supply via a first lead in the lead frame. The charging dock heating element generates heat when powered on to heat the charging dock.

### CROSS-REFERENCE TO RELATED APPLICATION

This application claims the benefit of the filing date under 35 U.S.C. § 119(a)-(d) of Chinese Patent Application No. CN202411832981.6 filed on Dec. 12, 2024, the whole disclosure of which is incorporated herein by reference.

### FIELD OF THE INVENTION

The present invention relates to a charging dock heating element and, more particularly, to a charging dock heating element, a lead frame assembly comprising the charging dock heating element, and a charging dock comprising the lead frame assembly.

### BACKGROUND OF THE INVENTION

With the rapid development of new energy vehicles, more and more new energy vehicle manufacturers are targeting cold regions such as Northern Europe, Russia, Canada, and others. However, in these cold regions, new energy vehicles will be affected by extreme cold weather. After charging is completed, the charging gun and charging dock may freeze due to water vapor condensation or rain and snow, and cannot be pulled out normally. This will affect the normal use of new energy vehicles in these cold regions.

### SUMMARY OF THE INVENTION

A charging dock heating element includes a body part. The body part is inserted into a slot of a housing of a charging dock. The charging dock heating element is electrically connected to a lead frame inside the housing of the charging dock. The charging dock heating element is electrically connected to a power supply via a first lead in the lead frame. The charging dock heating element generates heat when powered on to heat the charging dock.

### BRIEF DESCRIPTION OF DRAWINGS

The invention will now be described by way of example with reference to the accompanying figures, of which:

FIG. 1 is a perspective view of a lead frame assembly according to an exemplary embodiment;

FIG. 2 is an exploded view of the lead frame assembly of FIG. 1;

FIG. 3 is a rear side perspective view of the lead frame assembly of FIG. 1;

FIG. 4 is a cross-sectional view of the lead frame assembly of FIG. 1;

FIG. 5 is an exploded cross-sectional view of the lead frame assembly of FIG. 1;

FIG. 6 is a perspective view of a charging dock heating element according to an exemplary embodiment;

FIG. 7 is a front perspective view of a lead frame according to an exemplary embodiment;

FIG. 8 is a back perspective view of the lead of FIG. 7;

FIG. 9 is an exploded view of a temperature detection module according to an exemplary embodiment;

FIG. 10 is a perspective view of the lead frame assembly of FIG. 1 and a charging terminal, a signal terminal, and a grounding protection terminal of a charging dock according to an exemplary embodiment of the present invention, where the charging dock heating element of FIG. 6 of the charging dock is not shown;

FIG. 11 is a perspective view of the lead frame assembly of FIG. 1 and the charging terminal of FIG. 10, the signal terminal of FIG. 10, and the grounding protection terminal of FIG. 10, where the charging dock heating element of FIG. 6 is shown;

FIG. 12 is a perspective view of multiple leads in the lead frame of FIG. 7;

FIG. 13 is an exploded view of a housing and the charging dock heating element of FIG. 6 of the charging dock of FIG. 10;

FIG. 14 is an assembly view of the housing of FIG. 13 and the charging dock heating element of FIG. 6;

FIG. 15 is an assembly view of the housing of FIG. 13 and the lead frame assembly of FIG. 1 of the charging dock of FIG. 10;

FIG. 16 is a perspective view of the charging dock of FIG. 10; and

FIG. 17 is a partial exploded view of the charging dock as shown in FIG. 16.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

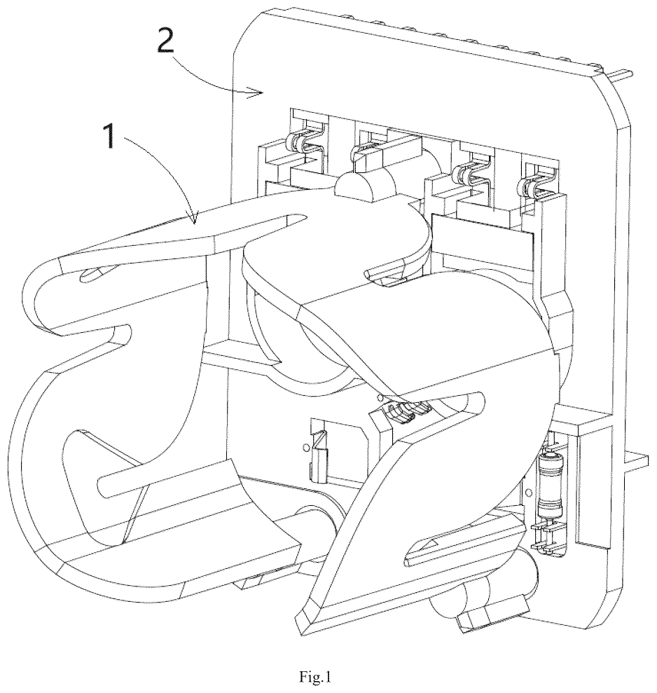

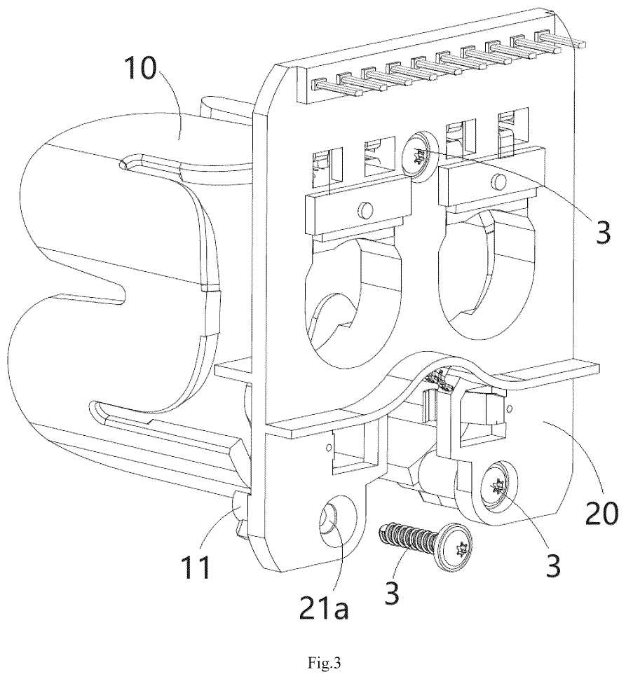

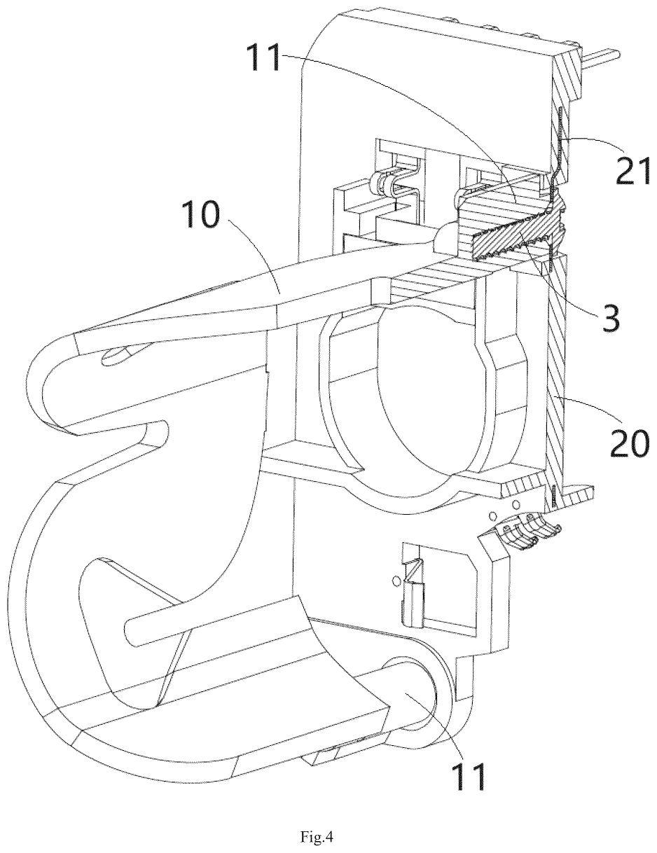

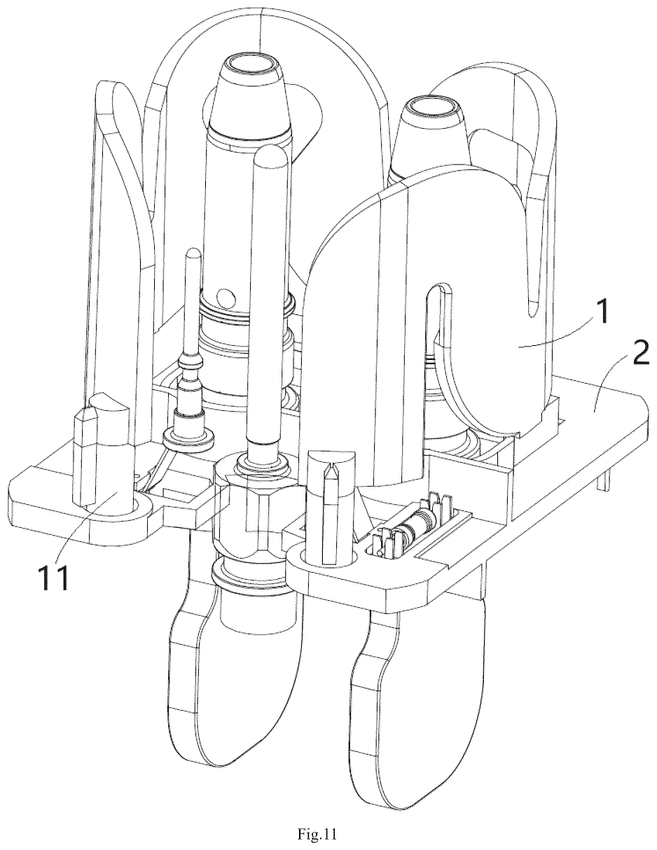

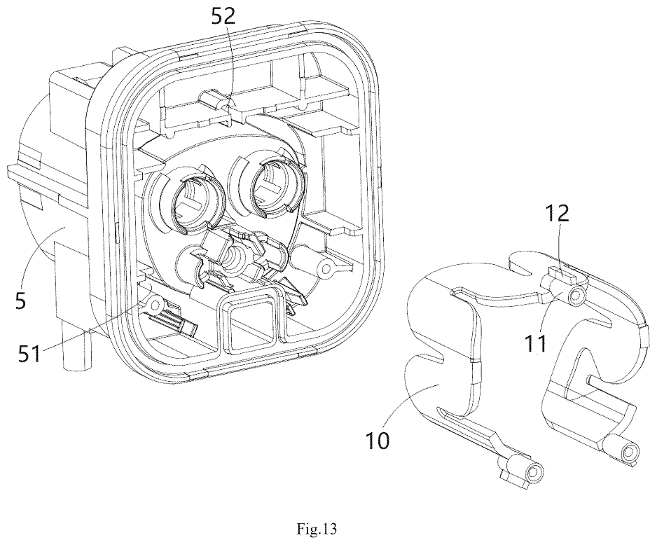

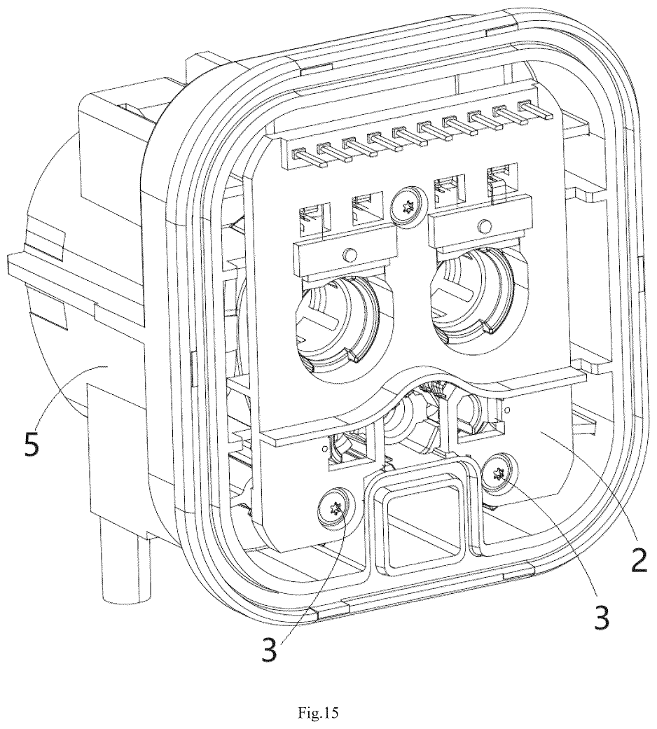

An exemplary embodiment of a charging dock heating element 1 will now be described with reference to FIGS. 1-17. The charging dock heating element 1 is suitable for being inserted into a slot 51 of a housing 5, as shown in FIG. 13, of a charging dock and for being electrically connected to a lead frame 2 inside the housing 5 of the charging dock, as shown in FIG. 15. The charging dock heating element 1 is suitable for being electrically connected to a power supply via a first lead 21 in the lead frame 2, and generates heat when powered on to heat the charging dock.

The charging dock heating element 1 is made of an electrically conductive and thermally conductive material. For example, the charging dock heating element 1 can be an integral injection molded part formed of electrically conductive and thermally conductive injection molding material.

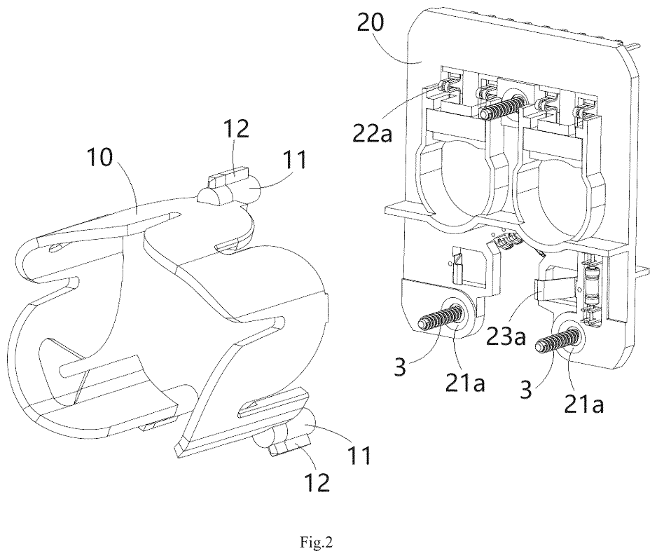

As shown in FIGS. 2 and 4-6, the charging dock heating element 1 includes a body part 10 and multiple connection parts 11. The body part 10 is suitable for being inserted into the slot 51 of the housing 5. Multiple connection parts 11 are suitable for being electrically connected to multiple first leads 21 of the lead frame 2, respectively.

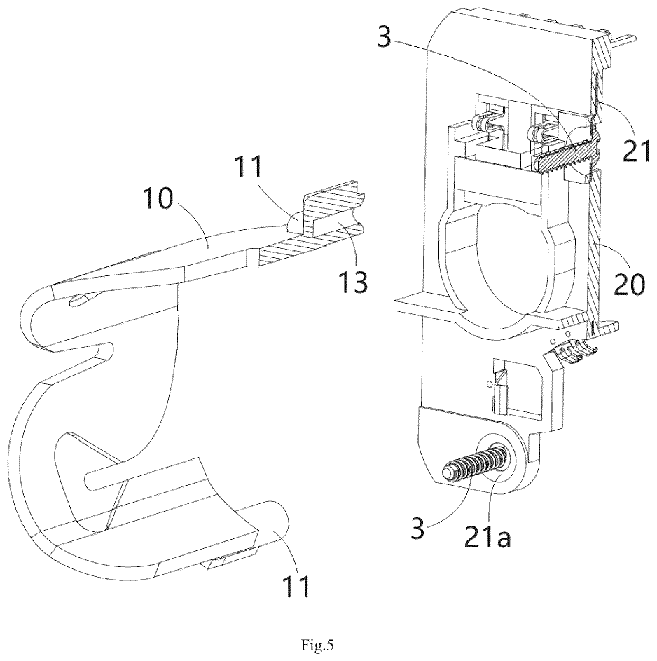

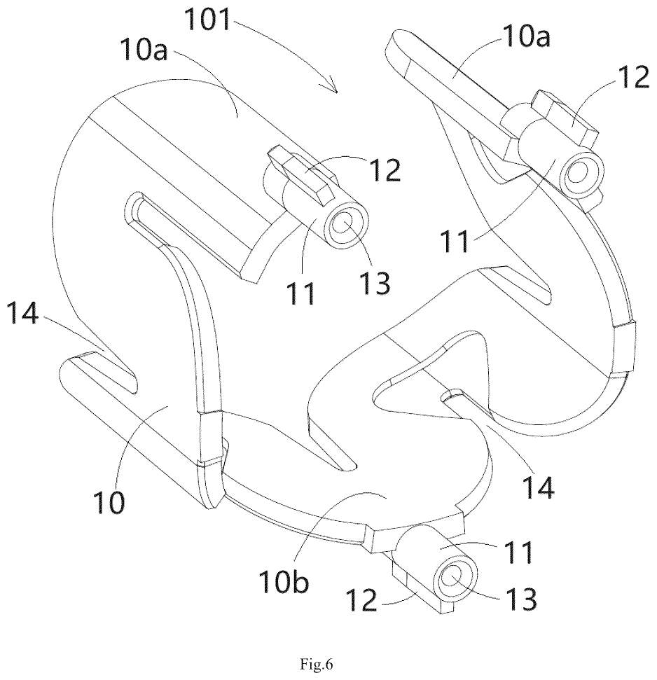

As shown in FIGS. 5-6, the connection part 11 is cylindrical and has a threaded hole 13 formed in the connection part 11, so that the connection part 11 can be mechanically and electrically connected to the first connection end 21a of the first lead 21 through a threaded connection member 3.

As shown in FIG. 6, the body part 10 is cylindrical with an opening 101, and has two end parts 10a that are opposite in the circumferential direction and respectively located on both sides of the opening 101. The body part 10 has front and rear sides that are opposite in the axial direction, and the connection part 11 is connected to the rear side of the body part 10 and extends axially backward from the rear side of the body part 10.

As shown in FIG. 6, multiple axially extending grooves 14 are formed on the front and rear sides of the body part 10, respectively. The grooves 14 on the front side of the body part 10 and the grooves 14 on the rear side of the body part 10 are alternately arranged in the circumferential direction of the body part 10.

As shown in FIG. 6, the charging dock heating element 1 includes three connection parts 11. The first and second of the three connection parts 11 are respectively connected to the rear sides of the two end parts 10a of the body part 10, and the third of the three connection parts 11 is connected to the rear side of the middle part 10b of the body part 10 opposite to the opening 101. The first and second of the three connection parts 11 are used to simultaneously electrically connect to one of the positive and negative poles of the power supply, and the third of the three connection parts 11 is used to electrically connect to the other of the positive and negative poles of the power supply.

As shown in FIGS. 2 and 6, a positioning key 12 is formed on the connection part 11, which protrudes radially along the body part 10 and extends a predetermined length along the axial direction of the body part 10. The positioning key 12 is adapted to engage with a positioning groove 52 inside the housing 5 to position the charging dock heating element 1 in the housing 5.

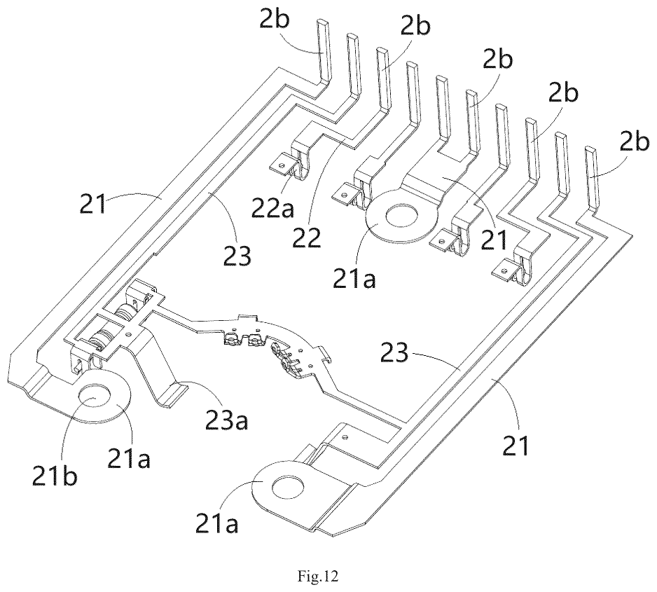

An exemplary embodiment of a lead frame assembly will now be described with reference to FIGS. 1-17. As shown in FIG. 1, the lead frame assembly includes a lead frame 2 and the aforementioned charging dock heating element 1. The lead frame 2 includes multiple leads 21, 22, 23, as shown in FIG. 12, and an insulator 20, as shown in FIGS. 2-5, and 7-9, injected onto the multiple leads 21, 22, 23 through an insert injection molding process. The charging dock heating element 1 is mechanically and electrically connected to the first lead 21 among multiple leads 21, 22, and 23.

As shown in FIGS. 2-3, 5, and 7, the first lead 21 has a first connection end 21a exposed from the insulator 20. The connection part 11 of the charging dock heating element 1 is mechanically and electrically connected to the first connection end 21a.

The first connection end 21a, as shown in FIGS. 2-3, 5, 7, and 12, is in the shape of a plate, and the connection part 11, as shown in FIGS. 2-6, 11, and 13-14, of the charging dock heating element 1 is in the shape of a column. One end of the connection part 11 is mechanically and electrically connected to the first connection end 21a.

A connection hole 21b, as shown in FIG. 12, is formed in the first connection end 21a of the first lead 21, and the threaded hole 13, as shown in FIGS. 5-6, corresponding to the connection hole 21b is formed in the connection part 11 of the charging dock heating element 1. As shown in FIGS. 2-5, 10, and 15, the lead frame assembly also includes a threaded connection member 3. The threaded connection member 3 passes through the connection hole 21b and is threaded with the threaded hole 13 to fasten the connection part 11 to the first connection end 21a of the first lead 21.

As shown in FIG. 12, the lead frame 2 includes multiple first leads 21, and the multiple connection parts 11 of the charging dock heating element 1 are mechanically and electrically connected to the first connection ends 21a of the multiple first leads 21, respectively.

As shown in FIG. 12, the lead frame 2 includes three first leads 21. The three connection parts 11 of the charging dock heating element 1 are mechanically and electrically connected to the first connection ends 21a of the three first leads 21, respectively. The first and second of the three first leads 21 are used to electrically connect to one of the positive and negative poles of the power supply, and the third of the three first leads 21 is used to electrically connect to the other of the positive and negative poles of the power supply.

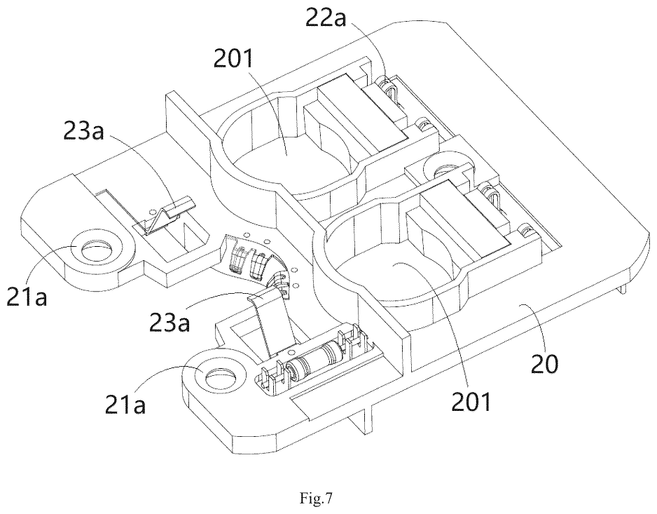

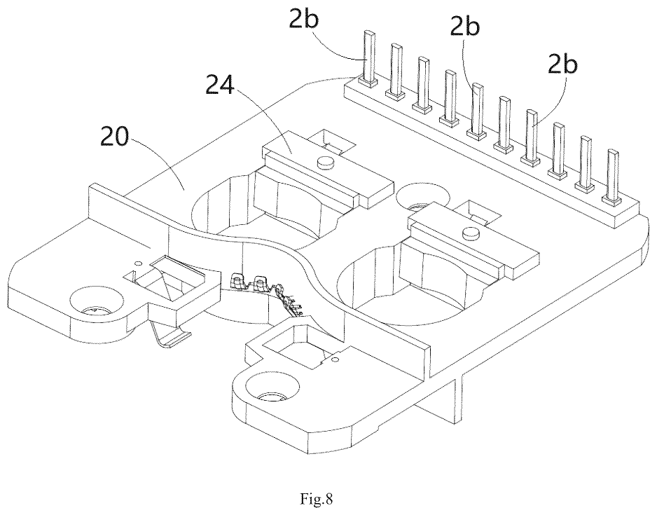

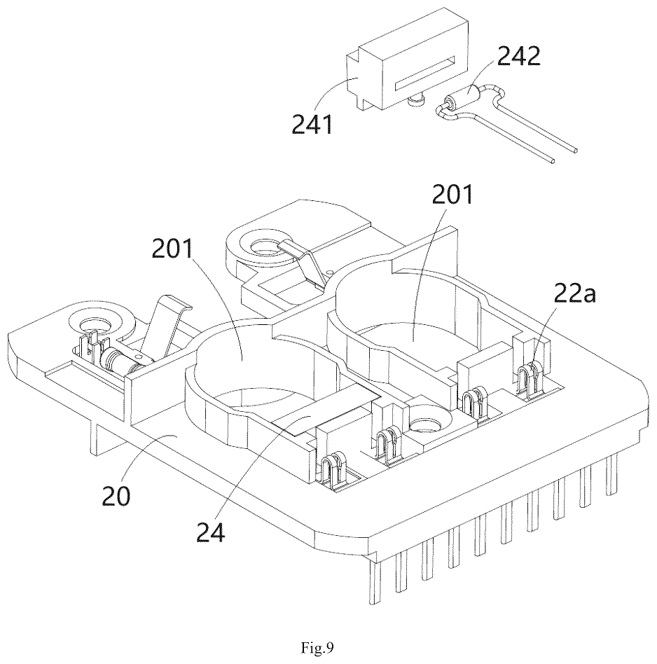

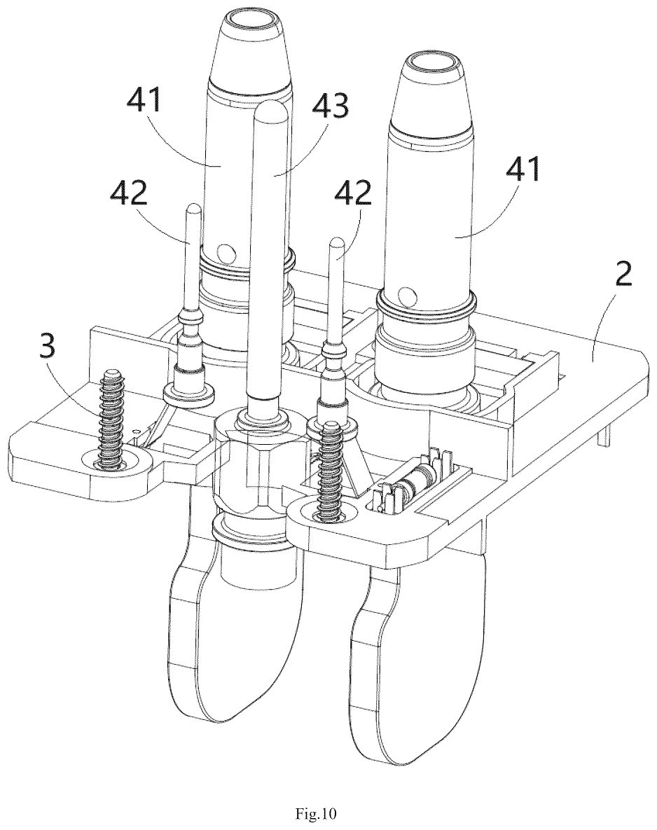

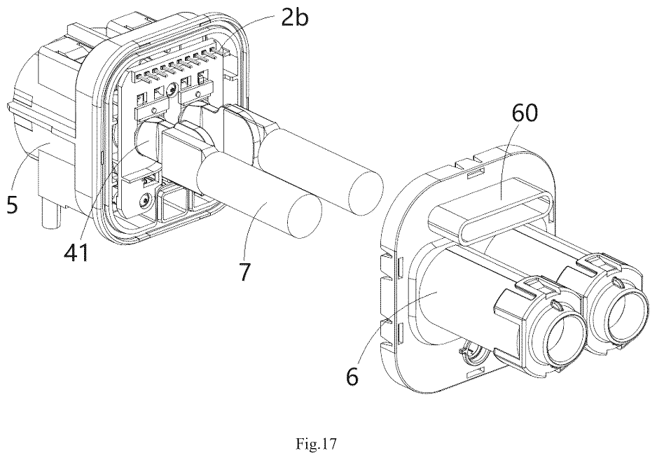

A through-hole 201, as shown in FIGS. 7 and 9, is formed in the lead frame 2 to allow a charging terminal 41, as shown in FIGS. 10 and 17, of the charging dock to pass through. The current on the charging terminal 41 during charging can reach up to 600 A, which can cause the temperature of the charging terminal 41 to rise. To prevent overheating of the charging terminal 41, it is necessary to monitor its temperature during charging. As shown in FIGS. 8-9, the lead frame assembly further includes a temperature detection module 24. The temperature detection module 24 is installed on the lead frame 2 to detect the temperature of the charging terminal 41 passing through the lead frame 2.

As shown in FIG. 9, the temperature detection module 24 includes a thermal pad 241 and a temperature sensor 242. The thermal pad 241 is installed on the insulator 20 of the lead frame 2. The temperature sensor 242 is installed in the thermal pad 241. The thermal pad 241 is suitable for thermal contact with the charging terminal 41 passing through the lead frame 2 to transfer the heat of the charging terminal 41 to the temperature sensor 242.

As shown in FIG. 12, the multiple leads 21, 22, and 23 of the lead frame 2 also include a second lead 22, which has a second connection end 22a exposed from the insulator 20. The second connection end 22a of the second lead 22 is electrically connected to the temperature sensor 242.

As shown in FIG. 12, the multiple leads 21, 22, and 23 of the lead frame 2 also include a third lead 23, which has a third connection end 23a exposed from the insulator 20. The third connection end 23a of the third lead 23 is used for electrical connection to a signal terminal 42, as shown in FIG. 10, of the charging dock.

As shown in FIGS. 8, 12, and 17, the multiple leads 21, 22, and 23 of the lead frame 2 each have a pin 2b exposed from the insulator 20. The pins 2b of the multiple leads 21, 22, and 23 are arranged in a row and are suitable for insertion into a low-voltage connector for electrical connection with the low-voltage connector.

An exemplary embodiment of a charging dock will now be described with reference to FIGS. 1-17. The charging dock includes a housing 5, as shown in FIGS. 13-17, and the aforementioned lead frame assembly. As shown in FIG. 13, a slot 51 is formed in housing 5. The lead frame assembly is installed in the housing 5. The charging dock heating element 1 of the lead frame assembly is inserted into the slot 51 of the housing 5.

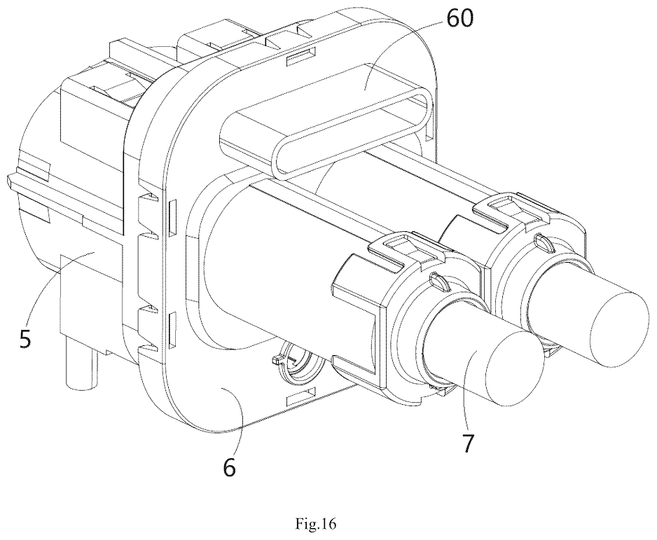

The charging dock further includes the charging terminal 41, as shown in FIG. 10, a back cover 6, as shown in FIGS. 16-17, and a charging cable 7, as shown in FIGS. 16-17. The charging terminal 41 is set in the housing 5 and passes through the lead frame 2 of the lead frame assembly. The back cover 6 is installed onto the rear end of the housing 5 to close the rear port of the housing 5. The charging cable 7 passes through the back cover 6 and is electrically connected to the rear end of the charging terminal 41. As shown in FIGS. 16-17, a mating part 60 is formed on the back cover 6. The pins 2b of the multiple leads 21, 22, and 23 of the lead frame 2 extend into the inner cavity of the mating part 60. The mating part 60 and the pins 2b of the multiple leads 21, 22, and 23 together form a mating connector suitable for mating with a low-voltage connector.

As shown in FIG. 10, the charging dock further comprises the signal terminal 42 and a grounding protection terminal 43 arranged in the housing 5. The charging dock heating element 1 is cylindrical with an opening 101, and the charging terminal 41, signal terminal 42, and grounding protection terminal 43 are located in the space enclosed by the charging dock heating element 1. The front ends of the charging terminal 41, the signal terminal 42, and the grounding protection terminal 43 are located in the front port of the housing 5 and are used to mate with a charging gun inserted into the front port of housing 5.

The temperature detection module 24 of the lead frame assembly is in thermal contact with the charging terminal 41 for detecting the temperature of the charging terminal 41. The charging dock heating element 1 is electrically connected to the first lead 21 among multiple leads 21, 22, and 23, the temperature sensor 242 of the temperature detection module 24 is electrically connected to the second lead 22 among multiple leads 21, 22, and 23, and the signal terminal 42 is electrically connected to the third lead 23 among multiple leads 21, 22, and 23.

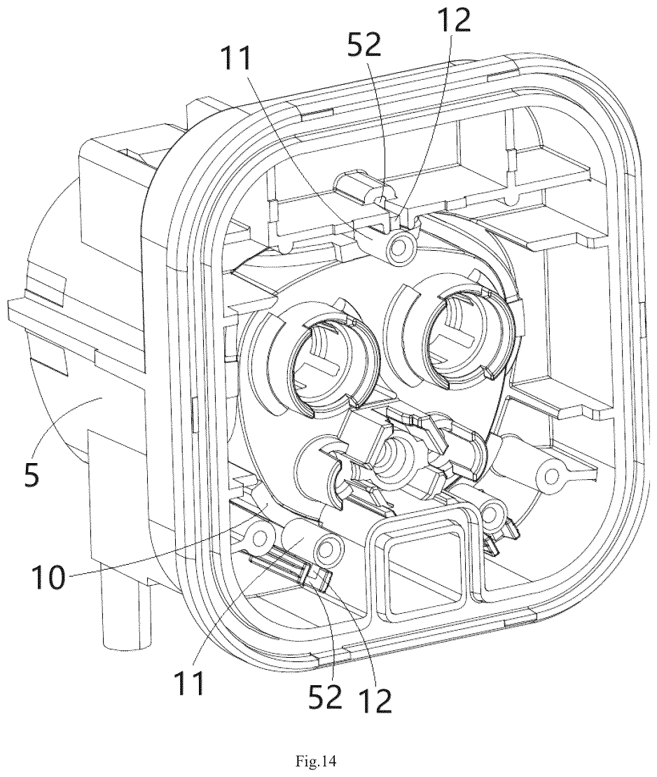

As shown in FIGS. 13-14, a positioning groove 52 is formed inside the housing 5. The positioning groove 52 is engaged with the positioning key 12 on the connection part 11 of the charging dock heating element 1 to position the charging dock heating element 1 in the housing 5.

In the aforementioned exemplary embodiments according to the present invention, after the charging of the new energy vehicle is completed, the charging dock heating element 1 can heat the charging dock, ensuring that the charging dock and the charging gun are not frozen, so that the charging gun can be pulled out after the charging is completed.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A charging dock heating element, comprising:
a body part, the body part is inserted into a slot of a housing of a charging dock, the charging dock heating element is electrically connected to a lead frame inside the housing of the charging dock, the charging dock heating element is electrically connected to a power supply via a first lead in the lead frame, the charging dock heating element generates heat when powered on to heat the charging dock.

2. The charging dock heating element of claim 1, wherein the charging dock heating element is made of an electrically conductive and thermally conductive material.

3. The charging dock heating element of claim 1, wherein the charging dock heating element is an integral injection molded part formed of electrically conductive and thermally conductive injection molding material.

4. The charging dock heating element of claim 1, wherein the charging dock heating element includes a plurality of connection parts, the connection parts are respectively electrically connected to a plurality of first leads of the lead frame.

5. The charging dock heating element of claim 4, wherein a threaded hole is formed in each connection part and each connection part is cylindrical, each connection part is mechanically and electrically connected to a first connection end of one first lead through a threaded connection member.

6. The charging dock heating element of claim 5, wherein the body part is cylindrical, has an opening, has two end parts opposite in a circumferential direction of the body part, and has a front side and a rear side opposite in an axial direction of the body part, each end part is at one of two sides of the opening, and each connection part is connected to the rear side of the body part and extends backwards along the axial direction from the rear side of the body part.

7. The charging dock heating element of claim 6, wherein a plurality of axially extending grooves are respectively formed on the front side and the rear side of the body part, the grooves on the front side of the body part and the grooves on the rear side of the body part are alternately arranged in the circumferential direction of the body part.

8. The charging dock heating element of claim 6, wherein the plurality of connection parts include three connection parts, a first connection part and a second connection part of the three connection parts are respectively connected to rear sides of the two end parts of the body part, and a third connection part of the three connection parts is connected to a rear side of a middle part of the body part, the middle part is opposite to the opening.

9. The charging dock heating element of claim 8, wherein the first connection part and the second connection part simultaneously electrically connect to one of a positive pole and a negative pole of the power supply, and the third connection part electrically connects to the other of the positive pole and the negative pole of the power supply.

10. The charging dock heating element of claim 4, wherein a positioning key is formed on each connection part, each positioning key protrudes radially along the body part and extends a predetermined length along an axial direction of the body part, each positioning key engages with a positioning groove inside the housing of the charging dock to position the charging dock heating element in the housing of the charging dock.

11. A lead frame assembly, comprising:
a lead frame including a plurality of leads and an insulator injection molded onto the leads; and
a charging dock heating element including a body part, the body part is inserted into a slot of a housing of a charging dock, the charging dock heating element is electrically connected to the lead frame inside the housing of the charging dock, the charging dock heating element is mechanically and electrically connected to a first lead of the plurality of leads, the charging dock heating element is electrically connected to a power supply via the first lead, and the charging dock heating element generates heat when powered on to heat the charging dock.

12. The lead frame assembly of claim 11, wherein the first lead has a first connection end exposed from the insulator, and a connection part of the charging dock heating element is mechanically and electrically connected to the first connection end.

13. The lead frame assembly of claim 12, wherein the first connection end is plate-shaped, and the connection part is cylindrical, one end of the connection part is mechanically and electrically connected to the first connection end.

14. The lead frame assembly of claim 13, wherein a connection hole is formed in the first connection end of the first lead, and a threaded hole corresponding to the connection hole is formed in the connection part, and the lead frame assembly further includes a threaded connection member which passes through the connection hole and is threaded with the threaded hole to fasten the connection part to the first connection end of the first lead.

15. The lead frame assembly of claim 12, wherein the lead frame has a plurality of first leads, a plurality of connection parts are respectively mechanically and electrically connected to the first connection end of the first leads.

16. The lead frame assembly of claim 12, wherein the lead frame has three first leads, three connection parts are respectively mechanically and electrically connected to the first connection end of the three first leads, a first and second of the three first leads electrically connect to one of a positive pole and a negative pole of the power supply, and a third of the three first leads electrically connects to the other of the positive pole and the negative pole of the power supply.

17. The lead frame assembly of claim 11, wherein a through-hole is formed in the lead frame to allow a charging terminal of the charging dock to pass through, and the lead frame assembly includes a temperature detection module installed on the lead frame for detecting a temperature of the charging terminal passing through the lead frame.

18. The lead frame assembly of claim 17, wherein the temperature detection module includes a thermal pad installed on the insulator of the lead frame and a temperature sensor provided in the thermal pad, the thermal pad thermally contacts the charging terminal passing through the lead frame to transfer the heat of the charging terminal to the temperature sensor.

19. The lead frame assembly of claim 18, wherein the plurality of leads of the lead frame include a second lead, the second lead has a second connection end exposed from the insulator, the second connection end of the second lead is electrically connected to the temperature sensor.

20. The lead frame assembly of claim 19, wherein the plurality of leads of the lead frame include a third lead, the third lead has a third connection end exposed from the insulator, the third connection end of the third lead is electrically connected to a signal terminal of the charging dock.

21. The lead frame assembly of claim 11, wherein each of the plurality of leads of the lead frame have a pin exposed from the insulator, each pin is arranged in a row and is inserted into a low-voltage connector for electrical connection with the low-voltage connector.

22. A charging dock, comprising:
a housing formed with a slot; and
a lead frame assembly installed in the housing and including a lead frame and a charging dock heating element, the lead frame includes a plurality of leads and an insulator injection molded onto the leads, the charging dock heating element includes a body part, the body part is inserted into the slot of the housing, the charging dock heating element is electrically connected to the lead frame inside the housing, the charging dock heating element is mechanically and electrically connected to a first lead of the plurality of leads, the charging dock heating element is electrically connected to a power supply via the first lead, and the charging dock heating element generates heat when powered on to heat the charging dock.

23. The charging dock of claim 22, further comprising a charging terminal, a back cover, and a charging cable, the charging terminal is set in the housing and passes through the lead frame of the lead frame assembly, the back cover is installed on a rear end of the housing to close a rear port of the housing, the charging cable passes through the back cover and is electrically connected to a rear end of the charging terminal, a mating part is formed on the back cover, and pins of the plurality of leads of the lead frame extend into an inner cavity of the mating part, the mating part and the pins together form a mating connector mating with a low-voltage connector.

24. The charging dock of claim 23, further comprising a signal terminal set in the housing and a grounding protection terminal provided in the housing, the charging dock heating element is cylindrical with an opening, and the charging terminal, the signal terminal, and the grounding protection terminal are located in a space enclosed by the charging dock heating element, front ends of the charging terminal, the signal terminal, and the grounding protection terminal are in a front port of the housing and mate with a charging gun inserted into the front port of the housing.

25. The charging dock of claim 24, wherein a temperature detection module of the lead frame assembly is in thermal contact with the charging terminal for detecting a temperature of the charging terminal, a temperature sensor of the temperature detection module is electrically connected to a second lead of the plurality of leads, and the signal terminal is electrically connected to a third lead of the plurality of leads.

26. The charging dock of claim 22, wherein a positioning groove is formed inside the housing, the positioning groove is engaged with a positioning key on a connection part of the charging dock heating element to position the charging dock heating element in the housing.
